(19) United States
(12) Patent Application Publication
(10) Pub. No.: US 2009/0089089 A1
(43) Pub. Date: Apr. 2, 2009

(54) APPARATUS AND METHOD FOR PROVIDING GERIATRIC CARE MANAGEMENT SERVICE

(76) Inventors: Hyun Chul JANG, Daejeon (KR); Joon Ho LIM, Daejeon (KR); Sa Kwang SONG, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/099,813

(22) Filed: Apr. 9, 2008

(30) Foreign Application Priority Data
Sep. 27, 2007 (KR) 10-2007-0097490

(51) Int. Cl. G06Q 50/00

(52) U.S. Cl. 705/2

(57) ABSTRACT

A method and apparatus provide geriatric care management service. The apparatus comprises a plurality of sensors, which generate sensor signals for informing daily behavior or health of an aged person, a signal processor, which analyzes the sensor signals to generate daily behavior information, an emergency situation manager, which informs a care giver that an emergency situation occurs and generates emergency situation occurrence information, an abnormal symptom manager, which analyzes the daily behavior information to informs the care giver whether or not the abnormal symptom occurs and generates abnormal symptom occurrence information, and a care information manager, which summarizes the daily behavior information, the emergency situation occurrence information, and the abnormal symptom occurrence information and generates care information.

### CROSS-REFERENCE TO RELATED APPLICATIONS

This application claims the priority of Korean Patent Application No. 10-2007-97490, filed on Sep. 27, 2007, in the Korean Intellectual Property Office, the disclosure of which is incorporated herein by reference.

### BACKGROUND OF THE INVENTION

1. Field of the Invention

The present invention relates to geriatric care management, and more particularly, to a method and apparatus for providing geriatric care management service, in which daily behavior information on an aged person is provided to a care giver who lives far away from the aged person, thereby enabling the care giver to recognize the time when the aged person needs a help to take a proper measure although the care giver does not always live together with the aged person.

The invention has been supported by IT R&D Program of MIC/IITA [2005-S-007-02, Ubiquitous Health Care Module System].

2. Description of the Related Art

As a nuclear family system is prevalent in recent times, the population of aged persons who live on their own without their care givers (or family members) is relatively increasing.

In this case, the best way is for the lonely aged person to visit the aged person to check the health of the aged person by eye.

However, the care giver has difficulty in periodically doing this thing in a modern busy life. In actuality, it frequently occurs that it is difficult even to inquire after the aged person's health on the phone by periods.

Although the care giver visits the lonely aged person to check the health of the aged person by eye, the care giver has difficulty in finding out any abnormality which the aged person is not conscious of in person by eye, and furthermore it is more difficult correctly checking the health of the aged person on the phone without a visit.

As such, even when the aged person needs outside help, the care giver fails to provide proper help, and thus the health of the aged person becomes worse.

Meanwhile, although the aged person lives together with the care giver, it takes much time and effort to continuously check the health of the aged person while the care giver always attends the aged person. This is also impossible in actuality.

In this manner, the aged person needs relatively more helps of the care giver, but the care giver has difficulty in exactly checking a time when the aged person requires the help to immediately take a measure.

Further, much manpower and expenses are required to check the state of the aged person in real time.

### SUMMARY OF THE INVENTION

The present invention has been made to solve the foregoing problems with the prior art, and therefore an aspect of the present invention provides a method and apparatus for providing geriatric care management service, which enables a care giver to recognize the time when an aged person needs a help to take a proper measure although the care giver does not always live together with the aged person.

According to an aspect of the present invention, a method for providing geriatric care management service comprises processes of: detecting daily behavior or health of an aged person through a plurality of sensors to generate daily behavior information; if the daily behavior information belongs to an emergency situation, immediately informing an occurrence of the emergency situation, and storing emergency situation occurrence information; when an abnormal symptom detecting cycle is reached, analyzing the pieces of daily behavior information stored for an abnormal symptom detecting period, checking and informing an occurrence of the abnormal symptom, and storing abnormal symptom occurrence information; and when a care information informing cycle is reached, summarizing the daily behavior information, the emergency situation occurrence information, and the abnormal symptom occurrence information, which are generated for a care information collecting period, generating and providing care information.

The process of informing an occurrence of the emergency situation comprises: checking whether or not the daily behavior information needs to take an emergency measure; checking a contact site, to which the occurrence of the emergency situation will be informed, if the daily behavior information needs to take an emergency measure; immediately informing the checked contact site of the occurrence of the emergency situation; and generating and storing the emergency situation occurrence information including at least one of information about the informed emergency situation, informing time information, and contact site information.

The process of immediately informing the checked contact site of the occurrence of the emergency situation comprises informing a care giver terminal of the occurrence of the emergency situation if the occurring emergency situation needs a help of a care giver, and informing a public institution terminal of the occurrence of the emergency situation if the occurring emergency situation needs a help of a public institution.

The process of immediately informing the checked contact site of the occurrence of the emergency situation further comprises defining the emergency situation and the contact site, each of which corresponds to each piece of daily behavior information which are required for the emergency measure.

The process of informing an occurrence of the abnormal symptom comprises: analyzing the pieces of daily behavior information accumulated for an abnormal symptom detecting period to check whether or not the abnormal symptom occurs; checking a contact site, to which the occurrence of the abnormal symptom will be informed, if it is checked that the abnormal symptom occurs; immediately informing the checked contact site of the occurrence of the abnormal symptom; and generating and storing the abnormal symptom occurrence information including at least one of information about the informed abnormal symptom, informing time information, and contact site information.

The process of immediately informing the checked contact site of the occurrence of the abnormal symptom comprises informing a care giver terminal of the occurrence of the abnormal symptom if the occurring abnormal symptom needs a help of a care giver, and informing a public institution terminal that the abnormal symptom occurs if the occurring abnormal symptom needs a help of a public institution.

The process of immediately informing the checked contact site of the occurrence of the abnormal symptom further comprises defining requirements for detecting the abnormal symptom and contact sites for informing the abnormal symptom.

The care information comprises at least one of the summarized daily behavior information, emergency situation occurrence information, and abnormal symptom occurrence information, and is displayed in a graph or table format.

According to another aspect of the present invention, an apparatus for providing geriatric care management service comprises: a plurality of sensors, which generate and transmit sensor signals for informing daily behavior or health of an aged person; a signal processor, which analyzes the sensor signals to generate daily behavior information; an emergency situation manager, which, when the daily behavior information belongs to an emergency situation, immediately informs a care giver of an occurrence of the emergency situation, and generates emergency situation occurrence information; an abnormal symptom manager, which analyzes the daily behavior information stored for an abnormal symptom detecting period, informs the care giver an occurrence of the abnormal symptom, and generates abnormal symptom occurrence information; and a care information manager, which summarizes the daily behavior information, the emergency situation occurrence information, and the abnormal symptom occurrence information, which are generated for a care information collecting period, generates care information, and providing the care information to a monitoring server.

The emergency situation manager further comprises a function of previously defining the emergency situation and contact site, each of which corresponds to the daily behavior information required for an emergency measure.

The emergency situation occurrence information comprises at least one of information about the emergency situation, informing time information, and contact site information.

The abnormal symptom manager further comprises a function of previously defining requirements for detecting the abnormal symptom and contact sites for informing the abnormal symptom.

The abnormal symptom occurrence information comprises at least one of information about the abnormal symptom, informing time information, and contact site information.

The care information is displayed in a graph or table format.

As set forth above, the method and apparatus for providing geriatric care management service collect the daily behavior information in a more active manner without imposing restriction on the daily behavior of the aged person, and provide the collected daily behavior information to the care giver or the public institution, so that the care giver or the public institution recognizes the time when the aged person requires a help to be able to take a proper measure.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates the operational concept of an apparatus for providing geriatric care management service according to an exemplary embodiment of the present invention;

FIG. 2 illustrates the configuration of an apparatus for providing geriatric care management service according to an exemplary embodiment of the present invention;

FIG. 3 is a flow chart illustrating a method for providing geriatric care management service according to an exemplary embodiment of the present invention;

FIG. 4 is a flow chart for explaining in greater detail emergency situation managing steps according to an embodiment of the present invention;

FIG. 5 is a flow chart for explaining in greater detail abnormal symptom managing steps according to an embodiment of the present invention;

FIG. 6 is a flow chart for explaining in greater detail care information managing steps according to an embodiment of the present invention; and

FIG. 7 is a flow chart for explaining in greater detail an informing method according to an embodiment of the present invention.

### DETAILED DESCRIPTION OF THE PREFERRED EMBODIMENT

Exemplary embodiments of the present invention will now be described in detail with reference to the accompanying drawings. In the following description, well-known functions or constructions by a man skilled in the art are not described in detail since they would obscure the invention in unnecessary detail.

Throughout the drawings, it is noted that the same reference numerals or letters will be used to designate like or equivalent elements having the same function.

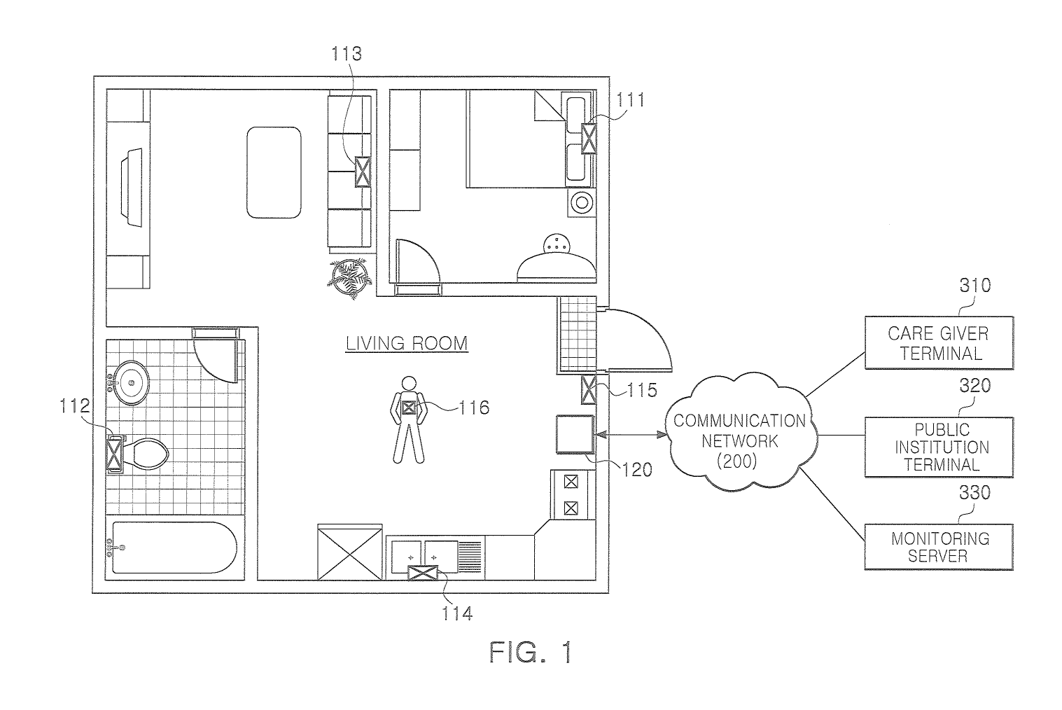

FIG. 1 illustrates the operational concept of an apparatus for providing geriatric care management service according to an exemplary embodiment of the present invention.

As illustrated in FIG. 1, the apparatus for providing geriatric care management service comprises a plurality of sensors 111 to 116 distributed at several positions of the body and the house of an aged person, and a control terminal 120 communicating with a terminal 310 of a care giver, a terminal 320 of public institution, and a monitoring server 330.

The plurality of sensors 111 to 116 are disposed at a bed, a dining table, a bathroom stool, a sofa, a front door, etc. in addition to the body of the aged person, and generate sensor signals for informing a daily behavior such as sleeping, having a meal, answering the call of nature, taking a rest or going out, and health of the aged person.

The control terminal 120 analyzes the sensor signals of the sensors 111 to 116, and checks the daily behavior and the health of the aged person from the analyzed results in real time.

When the checked daily behavior and the health of the aged person require an emergency measure or show abnormal symptom, the present situation is immediately notified to the care giver terminal 310 or the public institution terminal 320.

Further, information on the daily behavior and health of the aged person is provided to the monitoring server 330 by periods, so that it assists the care giver or the public institution to be able to monitor the daily behavior and the health of the aged person through the monitoring server 330.

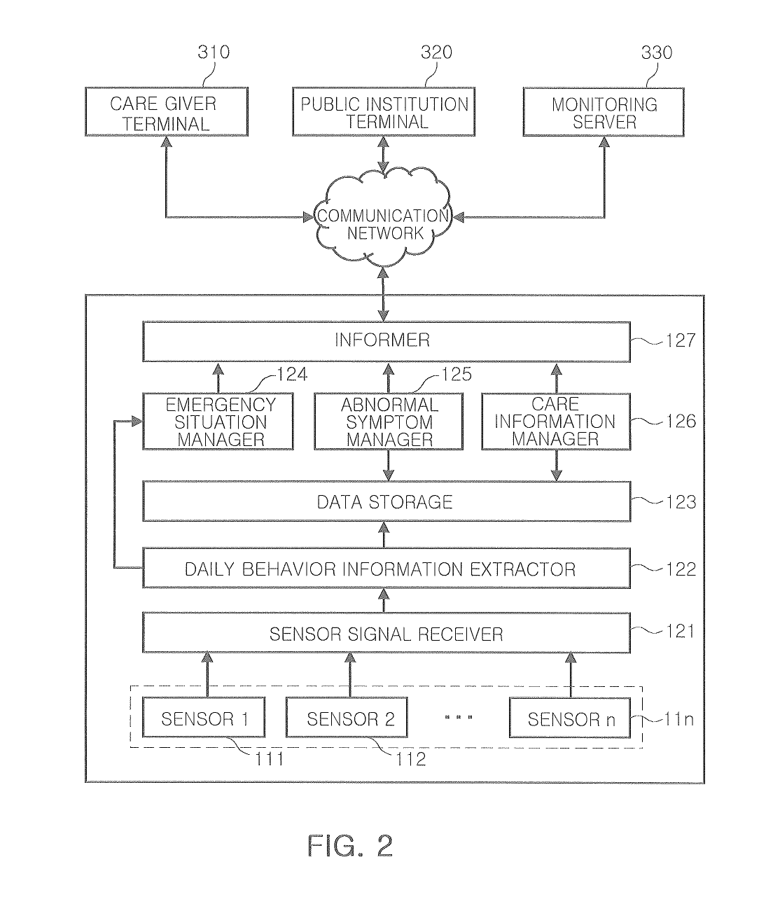

FIG. 2 illustrates the configuration of an apparatus for providing geriatric care management service according to an exemplary embodiment of the present invention.

Referring to FIG. 2, the apparatus 100 for providing geriatric care management service comprises a plurality of sensors 111 to 11n, a sensor signal receiver 121, a daily behavior information extractor 122, a data storage 123, an emergency situation manager 124, an abnormal symptom manager 125, a care information manager 126, and an informer 127, wherein the informer 127 is connected with the care giver terminal 310, the public institution terminal 320, and the monitoring terminal 330 over a communication network 200.

Here, the care giver terminal 310 includes a communication terminal, which any family member or a care giver of the aged person. The public institution terminal 320 includes a communication terminal of any public institution, which provides medical or complaint services to aged persons. Further, the monitoring terminal 300 includes a server, which operates a web page for posting various pieces of information provided by the apparatus 100 for providing geriatric care management service.

Now, the functions of the components will be described below.

The plurality of sensors 111 to 11n are distributed to the body and the house of the aged person, and each generate a sensor signal for informing the daily behavior or the health of the aged person.

For example, as in illustrated in FIG. 1, the plurality of sensors 111 to 11n are disposed at a bed, a bathroom, a sofa, a sink, a front door, etc. in the house in addition to the body of the aged person. More specifically, the sensor 11 disposed at the bed generates a sensor signal for informing a time for which the aged person sleeps. The sensor 112 disposed at the bathroom generates a sensor signal for informing a frequency at and a time for which the aged person answers the call of nature. The sensor 113 disposed at the sofa generates a sensor signal for informing a time for which the aged person takes a rest. The sensor 114 disposed at the sink generates a sensor signal for informing a frequency at and a time for which the aged person has a meal. The sensor 115 disposed at the front door generates a sensor signal for informing a frequency at and a time for which the aged person goes out. The sensor 116 disposed at the body of the aged person generates a sensor signal for informing the health of the aged person such as a heart rate, a blood pressure, and so on.

The sensor signal receiver 121 receives the sensor signals from the plurality of sensors 111 to 11n, converts them to singles which the daily behavior information extractor 122 can recognize, and then outputs the converted signals to the daily behavior information extractor 122 with sensor identification information added to each of the converted signals.

The daily behavior information extractor 122 previously defines requirements for extracting the daily behavior information and the daily behavior information required for the emergency measure, and analyzes the sensor signals transmitted from the sensor signal receiver 121 according to the extraction requirements. Thereby, the daily behavior information extractor 122 extracts the daily behavior information according to the analysis result, and stores the extracted information in the data storage 123. If the extracted daily behavior information needs to take an emergency measure, the daily behavior information extractor 122 immediately transmits the corresponding daily behavior information to the emergency situation manager 124.

The data storage 123 stores all of the daily behavior information extracted by the daily behavior information extractor 122, emergency situation occurrence information generated through the emergency situation manager 124, and abnormal symptom occurrence information generated through the abnormal symptom manager 125.

The emergency situation manager 124 previously defines an emergency situation that corresponds to each piece of daily behavior information required for the emergency measure as well as its contact site. If the daily behavior information required for the emergency measure is input from the daily behavior information extractor 122, the emergency situation manager 124 checks what kind of emergency situation the currently occurring emergency situation is, and where the contact site is, and then performs informing operation at once. Further, the emergency situation manager 124 generates the emergency situation occurrence information including information about the occurring emergency situation, informing time information, and contact site information, and stores the emergency situation occurrence information in the data storage 123.

The abnormal symptom manager 125 previously defines requirements for detecting abnormal symptoms as well as contact sites of the abnormal symptoms, and searches and analyzes the daily behavior information by periods. If any abnormal symptom is detected, the abnormal symptom manager 125 immediately informs the previously defined contact site that the abnormal symptom occurs. Further, the abnormal symptom manager 125 generates the abnormal symptom occurrence information including information about the abnormal symptoms, informing time information, and contact site information, and stores the abnormal symptom occurrence information in the data storage 123.

The care information manager 126 periodically summarizes each of the daily behavior information, the emergency situation occurrence information, and the abnormal symptom occurrence information, which are stored in the data storage 123 to generate care information, and then transmits the generated care information to the monitoring server 330.

The monitoring server 330 posts the received care information on its own web page, thereby enabling a care giver or a responsible person of public institution to monitor the daily behavior and health of the aged person on the basis of the posted care information.

This care information may express the summarized daily behavior information, emergency situation occurrence information, and abnormal symptom occurrence information using a graph or a table, so that the care giver or the responsible person of public institution can more easily recognize the daily behavior and health of the aged person.

The informer 127 is connected with the care giver terminal 310, the public institution terminal 320, and the monitoring terminal 330 over the communication network 200, and informs the care giver terminal 310 or the public institution terminal 320 whether or not the emergency situation or the abnormal symptom occurs under the control of the emergency situation manager 124 or the abnormal symptom manager 125, or transmits the care information to the monitoring server 330 under the control of the care information manager 126.

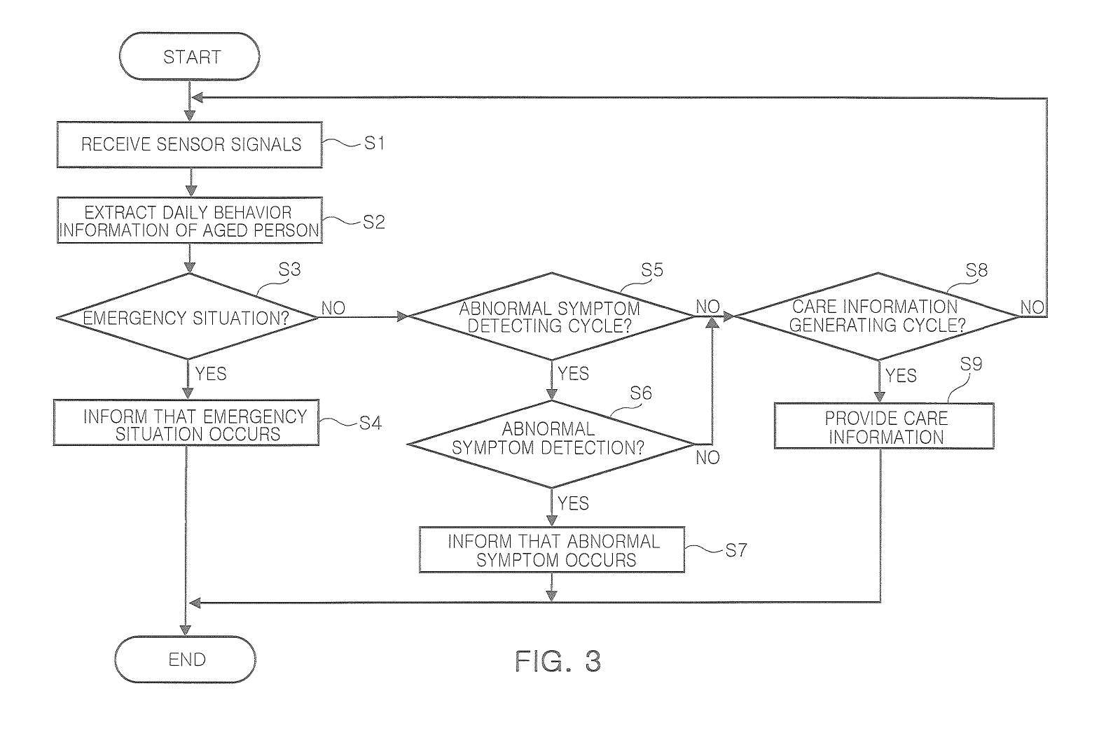

FIG. 3 is a flow chart illustrating a method for providing geriatric care management service according to an exemplary embodiment of the present invention.

The apparatus 100 for providing geriatric care management service obtains a plurality of sensor signals that inform the daily behavior and health of the aged person through the plurality of sensors 111 to 11n disposed at the body and house of the aged person (S1), and extracts the daily behavior information of the aged person from the sensor signals (S2).

It is checked that the daily behavior information extracted in step S2 needs to take an emergency measure (S3). If so, the care giver terminal 310 or the public institution terminal 320 is immediately informed that the emergency situation occurs. Then, emergency situation occurrence information is generated and stored (S4).

In contrast, if an abnormal symptom detecting cycle is reached (S5), various pieces of daily behavior information stored for an abnormal symptom detecting period are analyzed, and it is detected whether or not the abnormal symptom occurs (S6).

When the occurrence of the abnormal symptom is detected in step S6, the care giver terminal 310 or the public institution terminal 320 is informed that the abnormal symptom occurs. Then, abnormal symptom occurrence information is generated and stored (S7).

Further, if a care information informing cycle is reached (S8), various pieces of daily behavior information, emergency situation occurrence information, and abnormal symptom occurrence information, which are accumulated for a care information collecting period, are summarized to generate care information. Then, the care information is provided to the monitoring server 300 (S9).

The monitoring server 300 posts the care information, which is transmitted from the apparatus for providing geriatric care management service, on its own web page, thereby enabling the care giver or the responsible person of public institution to access the corresponding web page to monitor the daily behavior and health of the aged person at any time.

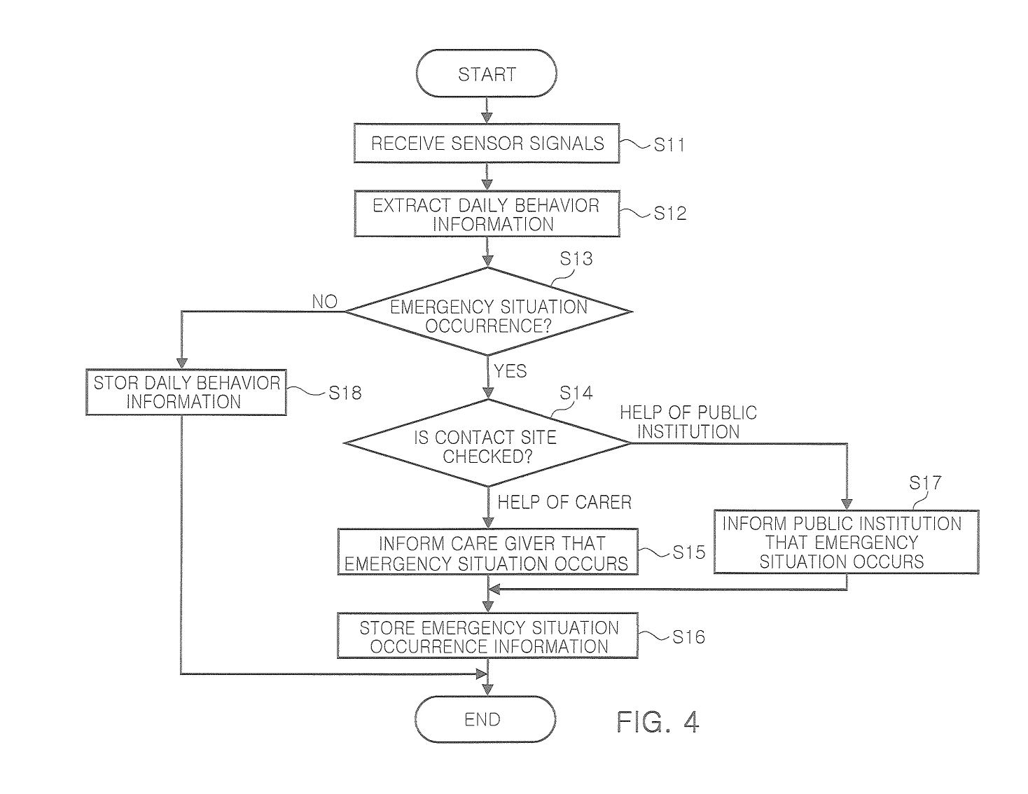

FIG. 4 is a flow chart for explaining in greater detail the emergency situation managing steps S1 to S4 according to an embodiment of the present invention.

First, the apparatus 100 for providing geriatric care management service obtains a plurality of sensor signals, which inform present daily behavior and health of the aged person, through the plurality of sensors 111 to 11n (S11). Then, the apparatus analyzes these sensor signals according to extraction requirements of daily behavior information, thereby extracting the daily behavior information of the aged person (S12).

It is checked whether or not the extracted daily behavior information of the aged person belongs to emergency situation that needs to take an emergency measure (S13). If so, it is checked where a contact site is in order to inform that the emergency situation occurs (S14).

As a result of step S14, if the occurring emergency situation needs a help of the care giver, the care giver terminal 310 is immediately informed that the emergency situation occurs (S15). Unlikely, if the occurring emergency situation needs a help of the public institution, the public institution terminal 320 is immediately informed that the emergency situation occurs (S16).

When the informing procedure is successively performed in step S15 or S16, various pieces of emergency situation occurrence information including information about the occurring emergency situation, informing time information, and contact site information are generated and stored (S17).

In contrast, as a result of step S13, if the daily behavior information extracted in step S12 does not belong to the emergency situation, the extracted daily behavior information of the aged person is stored. Then, the emergency situation managing step is determined (S18).

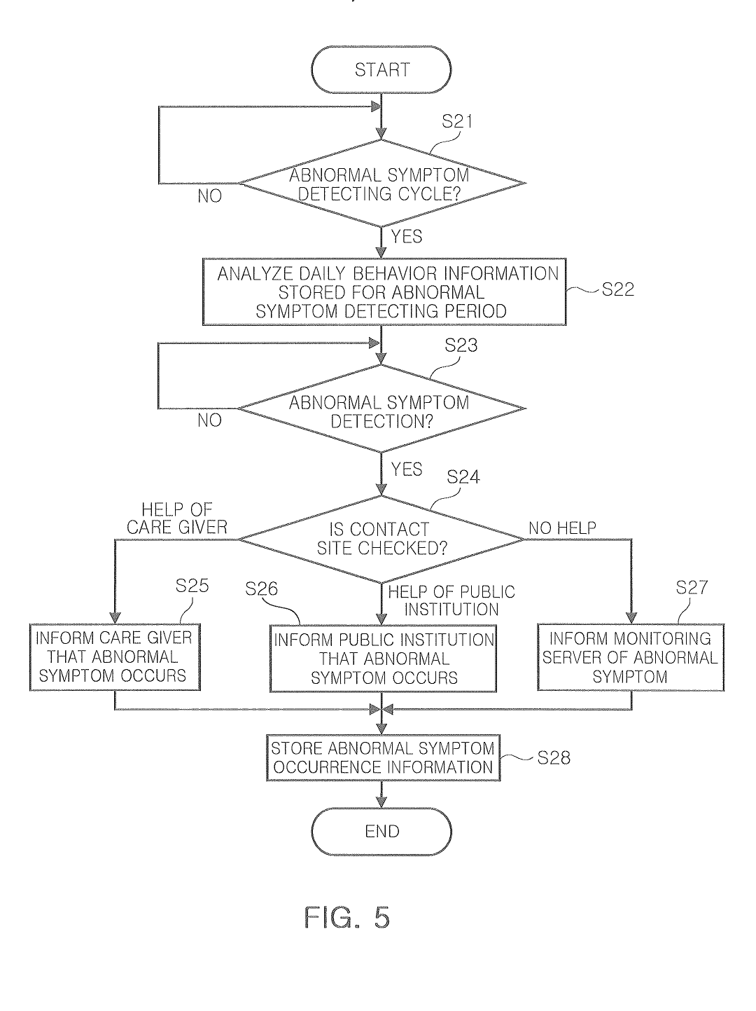

FIG. 5 is a flow chart for explaining in greater detail the abnormal symptom managing steps S5 to S7 according to an embodiment of the present invention.

Further, when an abnormal symptom detecting cycle is reached (S21), the apparatus 100 for providing geriatric care management service searches all pieces of daily behavior information stored for an abnormal symptom detecting period, and then analyzes them according to detection requirements of the abnormal symptom (S22). Thereby, it is checked whether or not the abnormal symptom occurs (S23).

As a result of step S23, when the occurrence of the abnormal symptom is detected, it is checked where a contact site is in order to inform this situation (S24).

As a result of step S24, if the occurring abnormal symptom needs a help of the care giver, the care giver terminal 310 is immediately informed that the abnormal symptom occurs (S25) Unlikely, if the occurring abnormal symptom needs a help of the public institution, the public institution terminal 320 is immediately informed that the abnormal symptom occurs (S26).

When the informing procedure is successively performed in step S25 or S26, various pieces of emergency situation occurrence information including information about the occurring abnormal symptom, informing time information, and contact site information are generated and stored (S27).

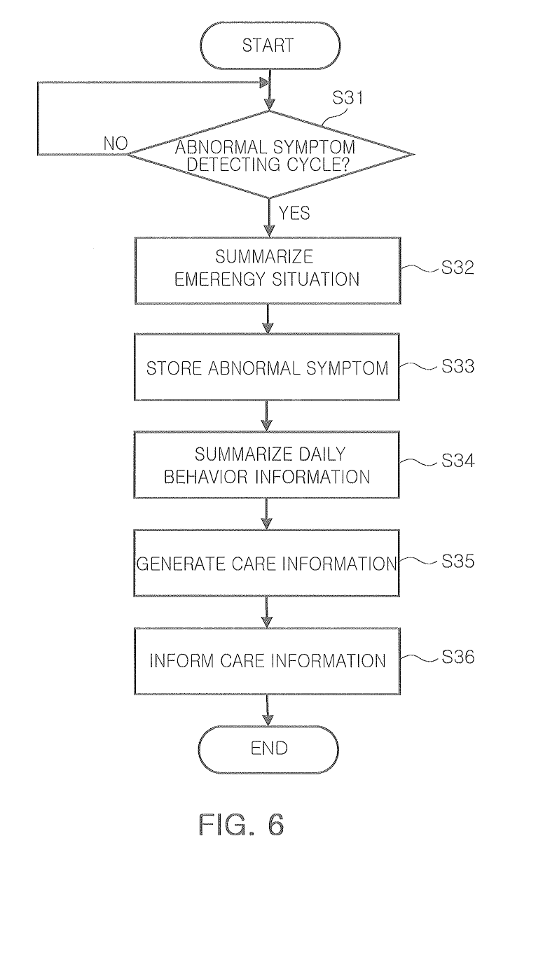

FIG. 6 is a flow chart for explaining in greater detail the care information managing steps S8 and S9 according to an embodiment of the present invention.

If a care information informing cycle is reached (S31), all pieces of emergency situation occurrence information, abnormal symptom occurrence information, and daily behavior information, which are stored for a care information collecting period, are collected and individually summarized (S32, S33 and S34).

In order to express all pieces of summarized information using a graph or table as described above, care information is generated (S35), and is transmitted to the monitoring server 330. The care information is posted on a web page of the monitor server 330 (S36).

Thus, the care giver or the public institution accesses the web page of the monitor server 330 through a communication network such as Internet, and searches and checks the care information of the aged person. Thereby, the care giver or the public institution can check present daily behavior and health of the aged person.

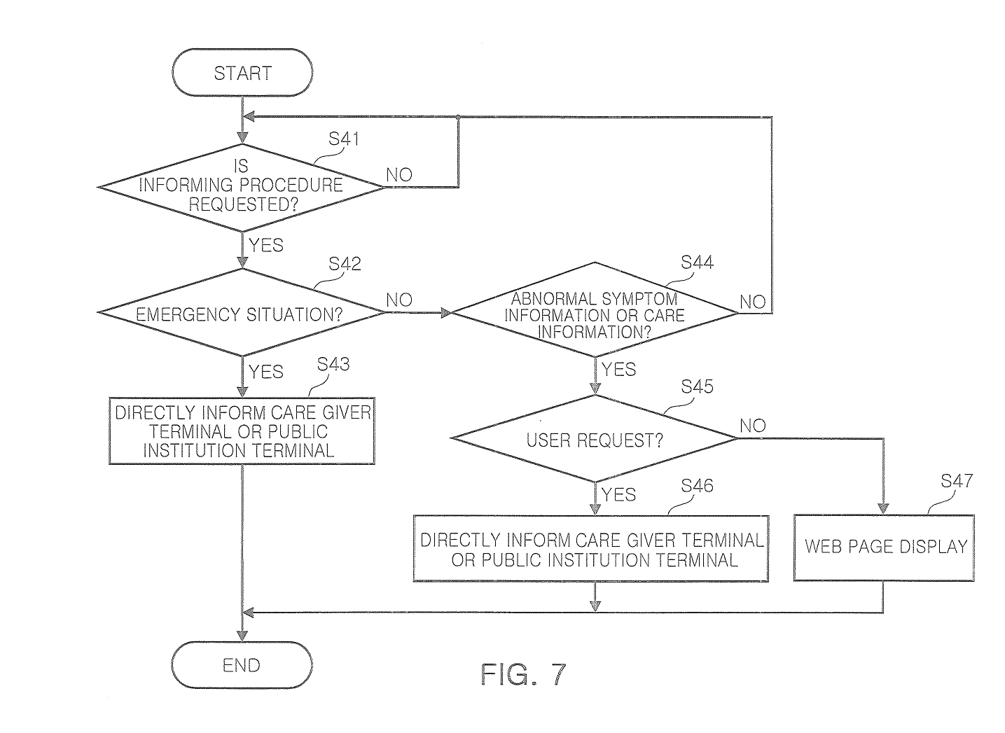

FIG. 7 is a flow chart for explaining in greater detail an informing method according to an embodiment of the present invention. This informing method is used when an informing procedure is performed through three types of steps: the emergency situation managing steps S1 to S4; the abnormal symptom managing steps S5 to S7; and the care information managing steps S8 and S9.

First, when the informing procedure for the three types of steps is requested (S41), the apparatus 100 for providing geriatric care management service checks whether or not the emergency situation occurs (S42).

As a result of step S42, the care giver terminal or the public institution terminal is directly informed that the emergency situation occurs (S43).

In contrast, if the emergency situation does not occur, it is checked whether or not the abnormal symptom occurrence information or the care information is requested (S44). If so, it is checked again whether or not the present informing procedure is requested by a user (S45).

If the present informing procedure is requested by a user, the abnormal symptom occurrence information or the care information is directly informed the care giver terminal 310 or the public institution terminal 320 (S46). If the present informing procedure is not requested by a user, the abnormal symptom occurrence information or the care information is transmitted to the monitoring server 330 so as to be posted on the web page of the monitoring server 330 (S47).

While the present invention has been shown and described in connection with the exemplary embodiments, it will be apparent to those skilled in the art that modifications and variations can be made without departing from the spirit and scope of the invention as defined by the appended claims.

What is claimed is:

1. A method for providing geriatric care management service comprising:
detecting daily behavior or health of an aged person through a plurality of sensors to generate daily behavior information;
if the daily behavior information belongs to an emergency situation, immediately informing an occurrence of the emergency situation, and storing emergency situation occurrence information;
when an abnormal symptom detecting cycle is reached, analyzing the pieces of daily behavior information stored for an abnormal symptom detecting period, checking and informing an occurrence of the abnormal symptom, and storing abnormal symptom occurrence information; and
when a care information informing cycle is reached, summarizing the daily behavior information, the emergency situation occurrence information, and the abnormal symptom occurrence information, which are generated for a care information collecting period, generating and providing care information.

2. The method of claim 1, wherein the informing an occurrence of the emergency situation comprises:
checking whether or not the daily behavior information needs to take an emergency measure;
checking a contact site, to which the occurrence of the emergency situation will be informed, if the daily behavior information needs to take an emergency measure;
immediately informing the checked contact site of the occurrence of the emergency situation; and
generating and storing the emergency situation occurrence information including at least one of information about the informed emergency situation, informing time information and contact site information.

3. The method of claim 2, wherein the immediately informing the checked contact site of the occurrence of the emergency situation comprises informing a care giver terminal of the occurrence of the emergency situation if the occurring emergency situation needs a help of a care giver, and informing a public institution terminal of the occurrence of the emergency situation if the occurring emergency situation needs a help of a public institution.

4. The method of claim 2, wherein the immediately informing the checked contact site of the occurrence of the emergency situation further comprises defining the emergency situation and the contact site, each of which corresponds to each piece of daily behavior information which are required for the emergency measure.

5. The method of claim 1, wherein the informing an occurrence of the abnormal symptom comprises:
analyzing the pieces of daily behavior information accumulated for an abnormal symptom detecting period to check whether or not the abnormal symptom occurs;
checking a contact site, to which the occurrence of the abnormal symptom will be informed, if it is checked that the abnormal symptom occurs;
immediately informing the checked contact site of the occurrence of the abnormal symptom; and
generating and storing the abnormal symptom occurrence information including at least one of information about the informed abnormal symptom, informing time information, and contact site information.

6. The method of claim 5, wherein the immediately informing the checked contact site of the occurrence of the abnormal symptom comprises informing a care giver terminal of the occurrence of the abnormal symptom if the occurring abnormal symptom needs a help of a care giver, and informing a public institution terminal that the abnormal symptom occurs if the occurring abnormal symptom needs a help of a public institution.

7. The method of claim 5, wherein the immediately informing the checked contact site of the occurrence of the abnormal symptom further comprises defining requirements for detecting the abnormal symptom and contact sites for informing the abnormal symptom.

8. The method of claim 1, wherein the care information includes at least one of the summarized daily behavior information, emergency situation occurrence information, and abnormal symptom occurrence information, and is displayed in a graph or table format.

9. An apparatus for providing geriatric care management service comprising:
a plurality of sensors generating and transmitting sensor signals to inform daily behavior or health of an aged person;
a signal processor analyzing the sensor signals to generate daily behavior information;
an emergency situation manager immediately informing a care giver of an occurrence of an emergency situation and generating emergency situation occurrence information, when the daily behavior information belongs to the emergency situation;
an abnormal symptom manager analyzing the daily behavior information stored for an abnormal symptom detecting period, informing the care giver of an occurrence of the abnormal symptom, and generating abnormal symptom occurrence information; and
a care information manager summarizing the daily behavior information, the emergency situation occurrence information, and the abnormal symptom occurrence information, which are generated for a care information collecting period, generating care information, and providing the care information to a monitoring server.

10. The apparatus of claim 9, wherein the emergency situation manager further comprises a function of previously defining the emergency situation and contact site, each of which corresponds to the daily behavior information required for an emergency measure.

11. The apparatus of claim 9, wherein the emergency situation occurrence information at least one of information about the emergency situation, informing time information, and contact site information.

12. The apparatus of claim 9, wherein the abnormal symptom manager further comprises a function of previously defining requirements for detecting the abnormal symptom and contact sites for informing the abnormal symptom.

13. The apparatus of claim 9, wherein the abnormal symptom occurrence information at least one of information about the abnormal symptom, informing time information, and contact site information.

14. The apparatus of claim 9, wherein the care information is displayed in a graph or table format.

15. The apparatus of claim 9, further comprising an informer informing one of a care giver terminal and a public institution terminal whether or not one of the emergency situation and the abnormal symptom occurs, or providing the care information to the monitoring server.

16. The apparatus of claim 9, further comprising a data storage storing the daily behavior information, the emergency situation occurrence information, and the abnormal symptom occurrence information.
